(19) United States
(12) Patent Application Publication
(10) Pub. No.: US 2016/0311620 A1
(43) Pub. Date: Oct. 27, 2016

(54) A Seafloor Vertical Hoisting System and Method

(71) Applicants: John Michael Parianos, Milton, Queensland (AU); Roland Gunter Berndt, Milton, Queensland (AU)

(72) Inventors: John Michael Parianos, Milton, Queensland (AU); Roland Gunter Berndt, Milton, Queensland (AU)

(73) Assignee: NAUTILUS MINERALS SINGAPORE PTE LTD, Singapore (SG)

(21) Appl. No.: 14/783,026

(22) PCT Filed: Apr. 3, 2014
(86) PCT No.: PCT/SG2014/000147

§ 371 Date: Oct. 7, 2015

(30) Foreign Application Priority Data
Apr. 8, 2013 (AU) 2013901290

(51) Int. Cl. B65G 17/12; E02F 7/02; B65G 37/00; B65G 17/36; B65G 17/42; B65G 33/08; E02F 7/00; B65G 11/00

(52) U.S. Cl. CPC B65G 17/126; E02F 7/005; E02F 7/023; B65G 11/00; B65G 17/36; B65G 17/42; B65G 33/08; B65G 37/00; B65G 2201/045

(57) ABSTRACT

A seafloor vertical hoisting system for hoisting ore from the seafloor, the hoisting system comprising a drive mechanism, at least one line adapted to be driven by the drive mechanism, a plurality of containers adapted to be operatively attached to the at least one line, a first casing adapted to at least partially encase the at least one line and the plurality of containers as they are hoisted relative to the seafloor and a second casing adapted to at least partially encase the at least one line and the plurality of containers as they are lowered towards the seafloor.

### FIELD OF THE INVENTION

The invention relates to a seafloor vertical hoisting system. The invention relates in particular, although not exclusively, to a system and method of mechanically hoisting ore from seafloor to surface in a subsea mining operation.

### BACKGROUND OF THE INVENTION

In various locations in the ocean, sulphide precipitates or polymetallic nodules exist in a surface layer on the bottom of the deep sea in water depths of around 300 to 6000 metres.

Since the late 1970's, there have been various attempts to engineer a commercially viable solution to mine and lift these deposits from the deep ocean seafloor.

One prior art solution is to hydraulically hoist the water and ore slurry to the surface. This solution comprises a vertical riser pipe and a single or series of inline slurry pumps to lift the water and ore slurry to the surface. Such systems are potentially quite complex, with significant wear occurring to the inline pumps, requiring maintenance during operation. For operations using multiple in-line centrifugal pumps, the energy efficiency of the system is quite low.

Another prior art solution is to airlift hoist the water and ore slurry to the surface. This solution comprises injecting air into a riser pipe part way down the pipe, the lower density of the air lifts the water and ore slurry to the surface. While this system is quite simple and has the attraction of potentially low maintenance during operation, it is relatively energy inefficient and requires significant quantities of high pressure compressed air to function at realistic hoisting rates.

An alternative prior art technology involves mechanically lifting by skip and cable, as is routinely used in many underground mines on land. Such mechanical hoisting systems are relatively simple as well as energy efficient. However, limitations on the potential throughput when using a single skip system, problems with guide and haulage cables becoming entangled in a multi skip system and, returning mud to the sea bottom and preventing contamination of the water column with plumes, all need to be considered in subsea applications.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### OBJECT OF THE INVENTION

It is an object of the invention to overcome or at least alleviate one or more of the above problems and/or provide the consumer with a useful or commercial choice.

Other preferred objects of the present invention will become apparent from the following description.

### SUMMARY OF THE INVENTION

In one form, although it need not be the only or indeed the broadest form, the invention resides in a seafloor vertical hoisting system for hoisting ore from the seafloor, the hoisting system comprising:

a drive mechanism;

at least one line adapted to be driven by the drive mechanism;

a plurality of containers adapted to be operatively attached to the at least one line; and

at least one casing adapted to at least partially encase the at least one line and the plurality of containers.

Preferably the seafloor vertical hoisting system comprises an ore receiving vessel. The ore receiving vessel may be a surface vessel, floating platform, semi-submersible or the like. In a preferred embodiment, the ore receiving vessel is a surface vessel. Typically, the drive mechanism is attached to the ore receiving vessel.

A skilled addressee will understand that the at least one line may be one or more rope, cable, belt, chain and/or the like. It will also be understood that a line may be multiple lines. For example a line can be multiple ropes connected together. Typically, the line is a continuous line forming a loop, with one side of the loop hoisting containers towards the surface and the other side bringing containers towards the seafloor.

Preferably each container is attached to a length of line that is adapted to connect to an adjacent container. In this manner, the length (i.e. depth) of the seafloor vertical hoisting system may be adjusted to suit the operational conditions. In an alternative embodiment, the containers may be attached to a single line that is spliced to form an endless loop. The containers may be attached to the line using clamps. For example, the containers may be attached to the line in a similar manner as ski lift gondolas are attached to cables.

Preferably each container will comprise guides to guide the containers inside the at least one casing. Preferably the guides are a plurality of guide rollers, which are adapted to contact an inner surface of the at least one casing.

Preferably each container is adapted to release any air that is inside the container as it is being lowered. Preferably each container comprises an aperture to allow air to escape from the container.

Preferably the at least one casing is formed from a plurality of conduits. Preferably the at least one casing is two casings. Preferably each casing is formed from a plurality of conduits. Typically one casing (a first casing) is an ‘up going’ casing, which encases at least part of the line and containers that are being hoisted towards the surface (i.e. hoisted relative to the seafloor). Typically, a second casing is a ‘down going’ casing, which encases at least part of the line and containers that are being lowered towards the seafloor. In an alternate embodiment, a ‘down going’ casing may not be required. For example, a ‘down going’ casing may not be required in cases where there is no need to prevent a plume of material being returned to the seafloor or where no material is being returned to the seafloor. Typically cross members are disposed between casings at intervals to space the casings apart.

Preferably the at least one casing has a larger inner cross sectional area compared to the cross sectional area of the containers, such that water can pass the containers as they are hoisted or lowered. In an alternative embodiment, the inner cross sectional area of the at least one casing is close to that of the containers. In this alternative embodiment, hollow cross members may be connected between ‘up going’ and ‘down going’ casings. In this manner, pressure differences may be equalised. A benefit of this is that parasitic drag is reduced. Alternatively or additionally, water and/or compressed air may be injected into an ‘up going’ casing to assist in the hoisting of the containers.

Preferably the drive mechanism is a driven spindle. Typically, the line and containers travel around part of the spindle and transition from being hoisted from the seafloor to being lowered to the seafloor. Preferably the containers are emptied of ore as they travel around at least part of the spindle. Alternatively the containers may be emptied after they have travelled around part of the spindle.

Typically the spindle is adapted to allow a container to travel at least partially around it (e.g. transition between being hoisted and being lowered).

Preferably the seafloor vertical hoisting system comprises a spindle towards the bottom of the hoisting system. Typically the spindle towards the bottom of the hoisting system acts as a return point for the line. Typically the spindle towards the bottom of the hoisting system is not driven by a motor. Alternatively the spindle towards the bottom of the hoisting system is driven to assist in the lowering and/or hoisting of the line.

Preferably the seafloor vertical hoisting system comprises an ore hopper towards the bottom of the hoisting system. Typically, ore is fed from the ore hopper into containers that are being hoisted towards the surface. Preferably a feeding mechanism such as an Archimedes screw feeder feeds ore from the ore hopper into the containers.

In another form, the invention resides in a spindle for a seafloor vertical hoisting system comprising:

a frame rotatably connected to a support; and

a plurality of sheaves rotatably connected to the frame and adapted to engage at least one line operatively connecting a plurality of containers.

Preferably the frame and the plurality of sheaves rotate in such a manner that the plurality of containers do not contact the sheaves. Typically, a container will be disposed between two of the plurality of sheaves as the container travels around at least part of the spindle. Typically, as a container travels around at least part of the spindle, the sheaves will be prevented from rotating relative to the frame. Typically when the sheaves are prevented from rotating relative to the frame, the frame is rotated such that the line and/or container can travel around at least part of the spindle.

Typically, when only the line is travelling around the spindle, the frame is prevented from rotating and the sheaves rotate relative to the frame.

Preferably, the sheaves and the frame are selectably rotated using motors.

It will be appreciated that the spindle may be an upper spindle, towards the top of the seafloor vertical hoisting system or a lower spindle towards the bottom of the seafloor vertical hoisting system.

In a further form, the invention resides in a spindle for a seafloor vertical hoisting system comprising:

a sheave rotatably connected to a support and adapted to engage at least one line operatively connecting a plurality of containers;

a cradle adapted to selectively rotate with the sheave and space each of the plurality of containers from the sheave as each of the plurality of containers travel around at least part of the sheave.

Preferably the cradle selectively attaches to the sheave in order to selectively rotate with the sheave.

Preferably the cradle comprises a recess that is adapted to receive at least part of each of the plurality of containers as they travel around at least part of the sheave.

Preferably the cradle is adapted to engage at least part of the line as the cradle rotates with the sheave around at least part of the spindle.

In yet another form, the invention resides in a method of constructing a seafloor vertical hoisting system, the method including the steps of:

providing a plurality of conduits;

connecting the plurality of conduits to form at least one casing;

lowering the at least one casing towards the seafloor;

providing at least one line operatively connecting a plurality of containers;

locating at least part of the at least one line within the at least one casing; and

providing a drive mechanism adapted to drive the at least one line.

Preferably, the step of lowering the at least one casing towards the seafloor is performed while the at least one casing is being formed.

Preferably the step of locating at least part of the at least one line within the at least one casing is performed while the at least one casing is being formed.

Preferably the method further includes the step of forming the at least one line into a continuous loop.

In another form, the invention resides in a method of hoisting ore from the seafloor, the method including the steps of:

providing ore from the seafloor to an ore hopper;

feeding ore from the ore hopper into a plurality of containers; and

hoisting the plurality of containers towards an ore receiving vessel;

wherein at least one line operatively connects the plurality of containers, and wherein at least part of the at least one line is located within at least one casing.

Further features of the invention will become apparent from the following description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1 shows a schematic view of a seafloor vertical hoisting system according to an embodiment of the invention and a seafloor nodule concentrating system;

FIG. 2 shows a schematic view of a seafloor vertical hoisting system according to an embodiment of the invention;

FIG. 3 shows a cross sectional schematic view of a container according to an embodiment of the invention;

FIG. 4 shows a schematic view of a seafloor vertical hoisting system according to an embodiment of the invention;

FIG. 5 shows a schematic plan view of an internal brace according to an embodiment of the invention;

FIG. 6 shows a schematic plan view of a lower spindle according to an embodiment of the invention;

FIG. 7 shows a schematic plan view of an external brace according to an embodiment of the invention;

FIG. 8 shows a schematic plan view of a lower spindle according to an embodiment of the invention;

FIG. 9 shows a schematic view of a seafloor vertical hoisting system according to an embodiment of the invention;

FIG. 10 A-F show schematic views of a spindle of FIG. 9; and

FIG. 11 A-E show schematic views of a spindle according to an embodiment of the invention.

### DETAILED DESCRIPTION OF THE DRAWINGS

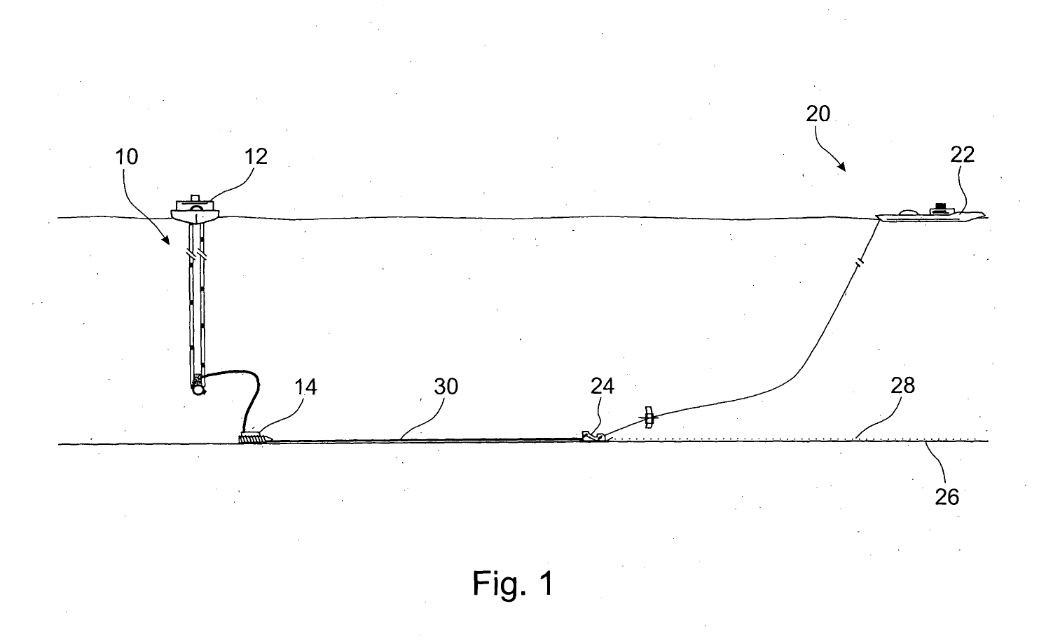

FIG. 1 shows a schematic view of a seafloor vertical hoisting system 10 according to an embodiment of the invention and a seafloor nodule concentrating system 20. The seafloor nodule concentrating system 20 comprises a surface vessel 22 and a seafloor nodule recovery vehicle 24 that is towed along the seafloor 26. The seafloor nodule recovery vehicle 24 collects ore in the form of nodules 28 from the seafloor 26 and deposits the ore in a windrow 30 behind the seafloor nodule recovery vehicle 24. An ore recovery apparatus 14 collects the ore windrow 30 and provides the ore to the vertical hoisting system 10 to hoist to an ore receiving vessel in the form of a surface vessel 12.

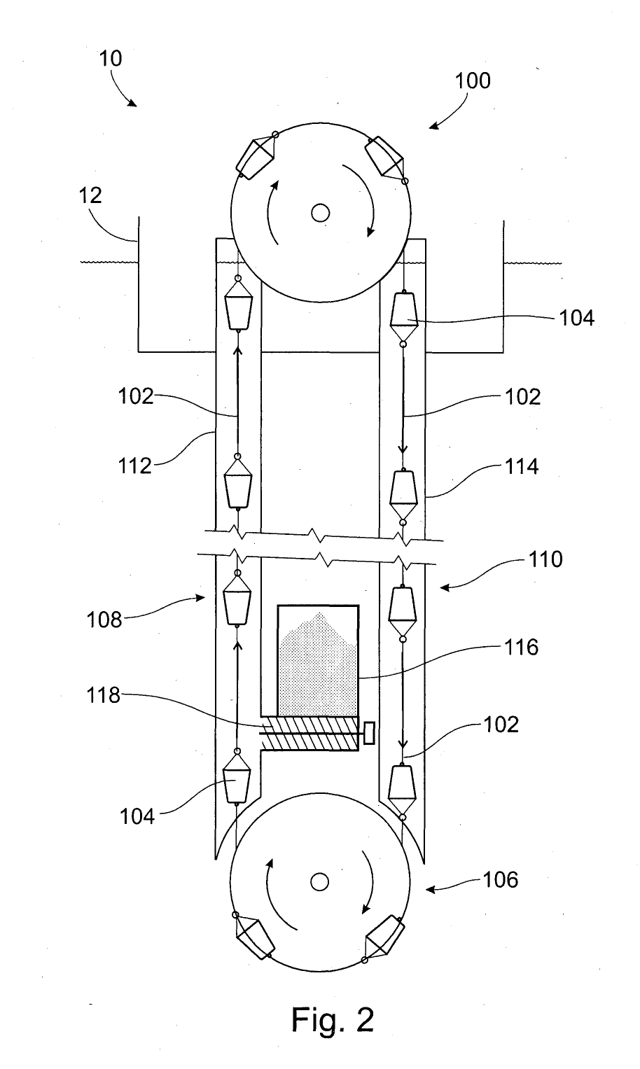

With reference to FIG. 2, there is shown a seafloor vertical hoisting system 10 according to an embodiment of the invention. The seafloor vertical hoisting system 10 has a drive mechanism in the form of an upper spindle 100 attached to an ore receiving vessel 12. The upper spindle 100 is typically driven by a motor (not shown) to hoist and lower a line 102 with multiple containers 104 attached thereto. It can be seen in the figure that the line 102 is made up of multiple segments, each of which attaches to a top of a container 104 and a bottom of an adjacent container 104.

The line 102 can be considered to be ‘continuous’ as it loops around the upper spindle 100 and a lower spindle 106, such that on a first side 108 of the seafloor vertical hoisting system 10, the line 102 and hence the containers 104 are hoisted towards the ore receiving vessel 12 and, on a second side 110, the line 102 and hence the containers 104 are lowered towards the seafloor (not shown).

A casing in the form of a pipe 112 encases most of the line 102 and containers 104 on the first side 108. A casing in the form of a pipe 114 encases most of the line 102 and containers 104 on the second side 110. Typically, the pipes 112,114 are formed by connecting multiple rigid sections (not shown). The pipes 112,114 are used to guide and contain the line 102 and containers 104. Typically the pipes 112,114 are suspended from the ore receiving vessel 12. In an alternate embodiment (not shown), the multiple rigid sections forming the pipes may be ‘stacked’ from a base plate located towards the bottom of the vertical hoisting system, the base plate being suspended from the ore receiving vessel by means of cable. A benefit of having the pipes 112,114 formed from multiple rigid sections and having a line 102 formed of multiple segments is that the length (i.e. depth) of the seafloor vertical hoisting system 10 can be adjusted to suit the operational conditions.

The lower spindle 106 is typically not driven by a motor, however, it will be appreciated that the lower spindle 106 may also be driven to assist in the hoisting and lowering of the line 102 and the containers 104.

An ore hopper 116 is located towards the lower end of the seafloor vertical hoisting system 10. A feeding mechanism in the form of an Archimedes screw feeder 118 feeds ore from the ore hopper 116 into the containers 104 that are being hoisted towards the ore receiving vessel 12. The ore hopper 116 is typically supplied with ore from an ore recovery apparatus (14, best seen in FIG. 1). Alternative feeding mechanisms such as chain or belt feeders could be employed instead of the Archimedes screw feeder.

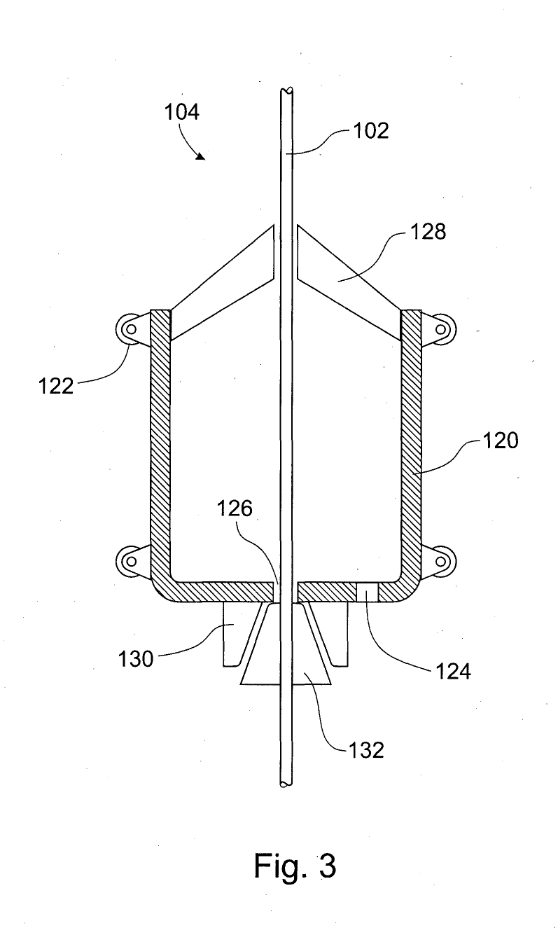

FIG. 3 shows a container 104 according to an embodiment of the invention. The container has a body 120, having roller guides 122 attached to an outside surface thereof. The roller guides 122 are adapted to contact an inner surface of a casing (not shown) to guide the container 104 during hoisting or lowering. The body 120 has an aperture in the form of an air drain hole 124. The air drain hole 124 allows air to escape from the container 104 as the container is lowered towards the seafloor (not shown). However, it will be appreciated that the body 120 may also be partly made of mesh.

The body 120 has an aperture 126, such that a line 102 can be threaded through the container 104. In an alternative embodiment (not shown), the body 120 may have a slot such that the line 102 can be placed into the container 104 without having to thread the line 102 through the container 104.

The container 104 has guides 128 to guide the line 102. The container has a mounting member 130 which connects with a clamp in the form of a clamping cone 132 attached to the line 102.

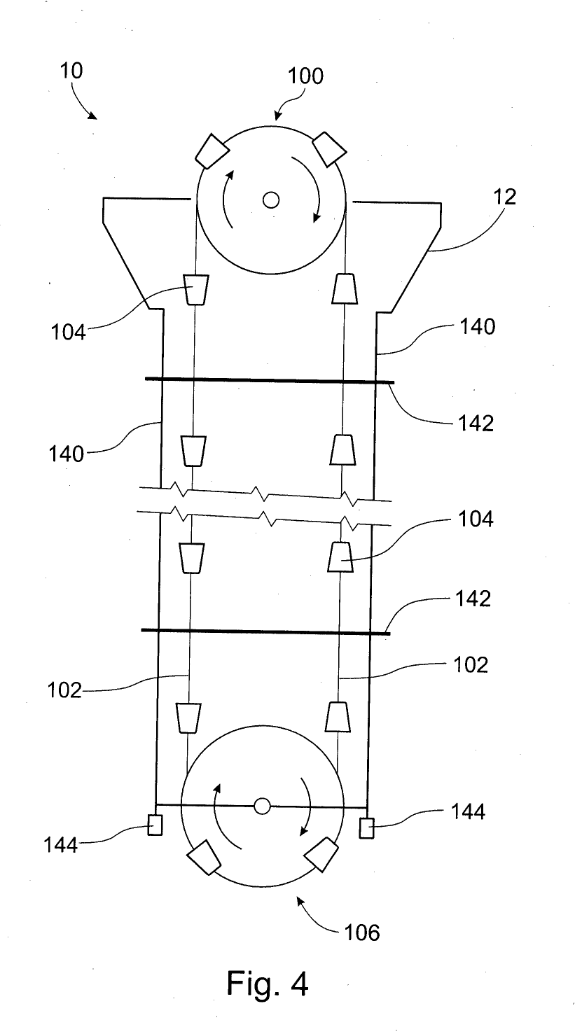

FIG. 4 shows a schematic view of a seafloor vertical hoisting system 10 according to an embodiment of the invention. The vertical hoisting system 10 is further supported by fixed lines in the form of fixed cables 140. The fixed cables 140 are connected at regular intervals by braces 142. Weights 144 are attached to the cables 140 to help stabilize the cables 140. It will be appreciated that fixed cables 140 may be located either outboard of the line 102 as shown in FIG. 4 or alternatively inboard of the line 102.

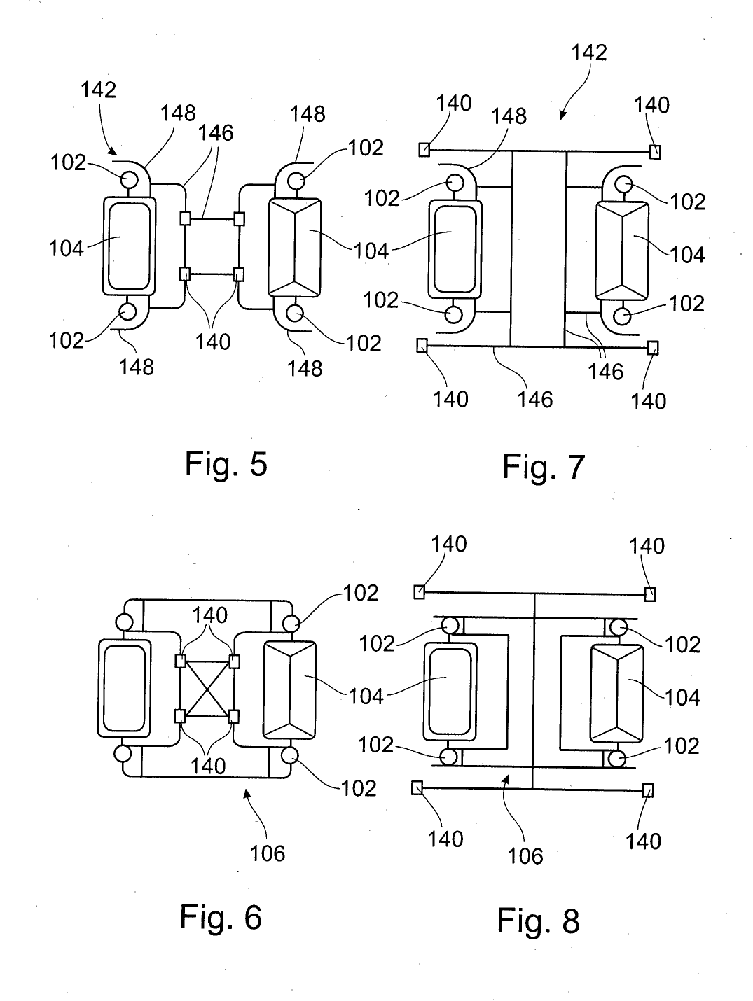

FIG. 5 shows a schematic plan view of a brace 142 according to an embodiment of the invention. The brace 142 has a frame 146 having fixed cables 140 attached towards a central portion of the frame 146. Line guides 148 are attached to the frame 146 and guide lines 102 which are attached to containers 104.

FIG. 6 shows a schematic plan view of a lower spindle 106 according to an embodiment of the invention. The lower spindle 106 is operatively attached to the fixed cables 140, such that the lower spindle 106 can rotate relative to the fixed cables 140. The lower spindle 106 engages with lines 102 such that the lines 102 and hence containers 104 are guided around part of the lower spindle 106 as the lines 102 and containers 104 transition from being lowered to being hoisted.

FIG. 7 shows a schematic plan view of a brace 142 according to an embodiment of the invention. The brace 142 has a frame 146 having fixed cables 140 attached towards outer portions of the frame 146. Line guides 148 are attached to the frame 146 and guide lines 102 which are attached to containers 104.

FIG. 8 shows a schematic plan view of a lower spindle 106 according to an embodiment of the invention. The lower spindle 106 is operatively attached to a frame 146, such that the lower spindle 106 can rotate relative to the frame 146. The frame 146 is attached to fixed cables 146. The lower spindle 106 engages with lines 102 such that the lines 102 and hence containers 104 are guided around part of the lower spindle 106 as the lines 102 and containers 104 transition from being lowered to being hoisted.

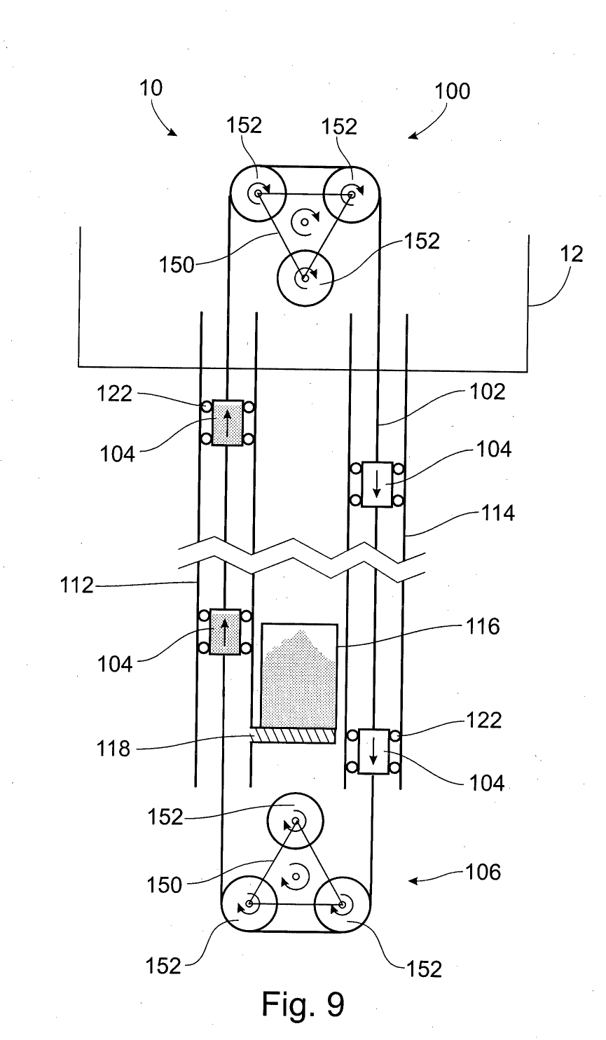

FIG. 9 shows a schematic view of a seafloor vertical hoisting system 10 according to an embodiment of the invention. Similar to FIG. 2, pipes 112,114 are used to guide and contain the line 102 and containers 104. The containers have roller guides 122. The roller guides 122 are adapted to contact an inner surface of the pipes 112,114 to guide the containers 104 during hoisting or lowering. Similar to FIG. 2, the containers are filled with ore from an ore hopper 116 by an Archimedes screw feeder 118.

The upper spindle 100 and lower spindle 106 have a rotatable frame 150 and sheaves 152 rotatably connected to the frame 150. In this manner, the containers 104 can travel around the upper spindle 100 and the lower spindle 106 without having to pass over a sheave 152. The operation of the spindles 100,106 will be explained in more detail below.

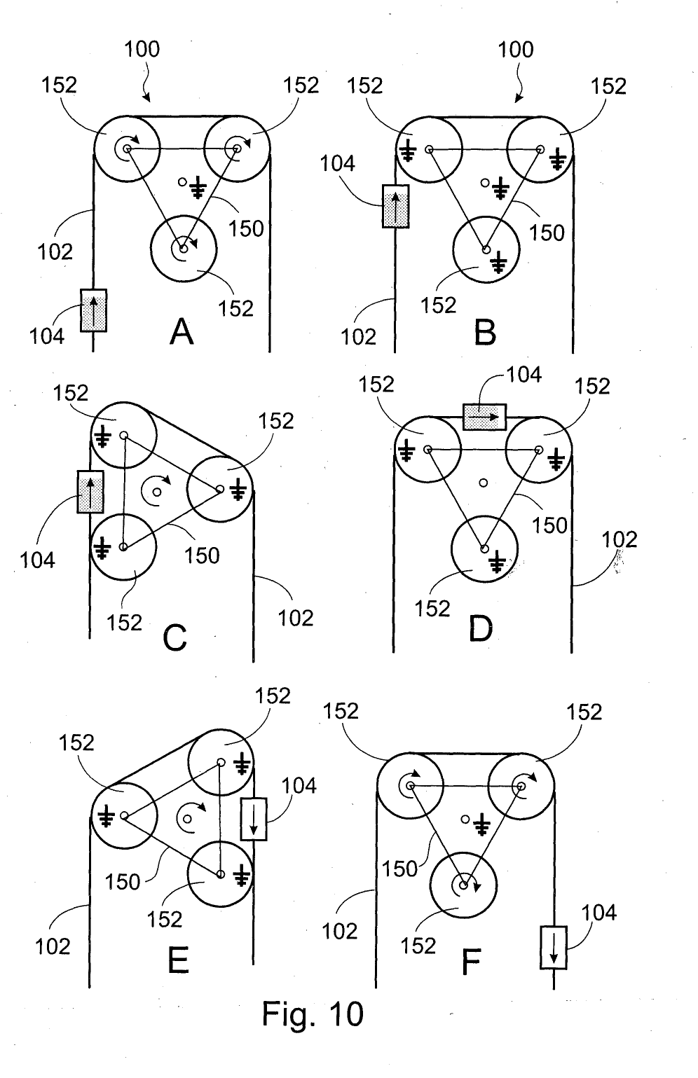

With regard to FIGS. 10a-10f, there is shown the operation of an upper spindle 100 of FIG. 9.

FIG. 10a shows a container 104 approaching the upper spindle 100. At this stage, the rotatable frame 150 is prevented from rotating and the sheaves 152 are rotating relative to the frame to drive the line 102.

Once the container is sensed in a predetermined position as seen in FIG. 10b, the sheaves are prevented from rotating relative to the frame.

The frame is then rotated as seen in FIGS. 10c-10e such that the container 104 travels around part of the spindle 100 between two sheaves 152. Typically, the transition between 10b and 10c is such that the line 102 does not stop moving around the upper spindle 100. Although the sheaves do not rotate relative to the frame 150, the line 102 is still being driven by the sheaves 152 due to the rotation of the frame 150. As can be seen from FIGS. 10d-10e, the container 104 is emptied as it travels around the upper spindle 100.

Once the sheaves 152 are in a position as seen in FIG. 10f, the frame 150 is prevented from rotating and the sheaves 152 are rotated such that the container 104 can be lowered. The process as seen in FIGS. 10a-10f can then be repeated for another container approaching the upper spindle 100.

It will be appreciated that a lower spindle (not shown) may function in a similar manner as the upper spindle shown in FIGS. 10a-10f, bearing in mind that the lower spindle may not be driving a line, instead, the lower spindle may be driven by a line, and bearing in mind that containers are not emptied as they travel around the lower spindle.

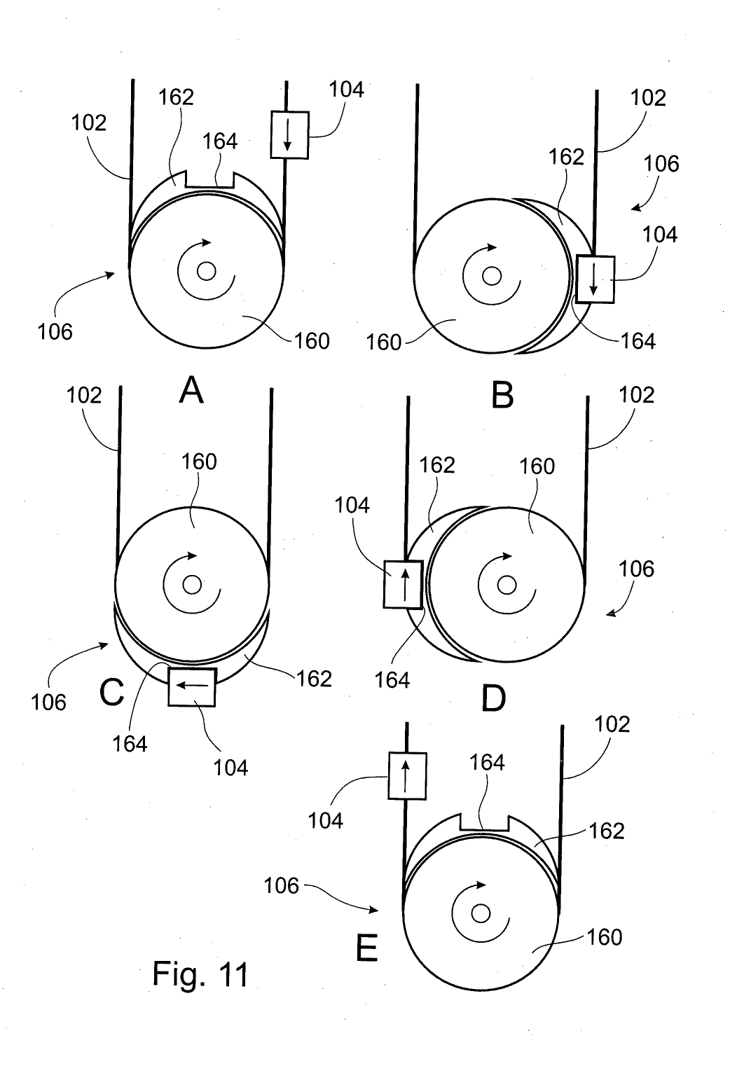

With regard to FIGS. 11a-11e, there is shown the operation of a lower spindle 106 according to an embodiment of the invention.

With reference to FIG. 11a, the lower spindle 106 has a sheave 160 that is driven by the line 102. It will be appreciated that the sheave 160 may be driven to assist in the lowering and hoisting of the line 102 and containers 104. A cradle 162 is positioned adjacent the sheave 160. The cradle 162 is crescent shaped and has a recess 164 that is adapted to accommodate at least part of the container 104, as well as a groove (not shown) of the same configuration as a groove (not shown) on the sheave 160 to accommodate the line 102. When the container 104 is sensed in a predetermined location, as seen in FIG. 11a, the cradle 162 turns with the sheave 160. This may be achieved by locking the cradle 162 to the sheave 160.

As can be seen with reference to FIGS. 11b-11d, the cradle 162 turns with the sheave 160. Part of the container 104 is received in the recess 164 of the sheave 160. The container 104 travels around part of the spindle 106 spaced from the sheave 160 by the cradle 162.

As can be seen from FIG. 11e, once the container 104 has travelled around the lower spindle 106 (i.e. around part of the lower spindle), the cradle 162 remains adjacent the sheave 160 until another container approaches the lower spindle 106 and the process as seen in FIGS. 11a-11e can be repeated.

It will be appreciated that an upper spindle (not shown) may function in a similar manner as the lower spindle shown in FIGS. 11a-11e, bearing in mind that the upper spindle may be driving a line, and bearing in mind that containers are typically emptied as they travel around the upper spindle.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

1. A seafloor vertical hoisting system for hoisting ore from the seafloor, the hoisting system comprising:
an ore receiving vessel;
a drive mechanism attached to the ore receiving vessel;
at least one line adapted to be driven by the drive mechanism;
a plurality of containers adapted to be operatively attached to the at least one line;
a first casing adapted to at least partially encase the at least one line and the plurality of containers as they are hoisted relative to the seafloor; and
a second casing adapted to at least partially encase the at least one line and the plurality of containers as they are lowered towards the seafloor.

2. A seafloor vertical hoisting system as claimed in claim 1, wherein the drive mechanism is a driven spindle.

3. A seafloor vertical hoisting system as claimed in claim 1, wherein each of the first and second casings is formed of a plurality of conduits.

4. A seafloor vertical hoisting system as claimed in claim 1, wherein the at least one line is formed of multiple segments, each of which attaches to a top of a corresponding container of the plurality of containers and a bottom of an adjacent container of the plurality of containers.

5. A seafloor vertical hoisting system as claimed in claim 1, wherein each of the plurality of containers has an aperture such that the at least one line can be threaded through each of the plurality of containers.

6. A seafloor vertical hoisting system as claimed in claim 1, wherein each of the plurality of containers comprise a plurality of guide rollers which are adapted to contact an inner surface of the first or second casings to guide the corresponding container during hoisting or lowering of the corresponding container.

7. A seafloor vertical hoisting system as claimed in claim 1, comprising an ore hopper towards a lower end of the seafloor vertical hoisting system.

8. A seafloor vertical hoisting system as claimed in claim 7, wherein an Archimedes screw feeder feeds ore from the ore hopper into the plurality of containers.

9. A seafloor vertical hoisting system as claimed in claim 7, further comprising an ore recovery apparatus, wherein the ore recovery apparatus supplies ore to the ore hopper.

10. A seafloor vertical hoisting system as claimed in claim 1, wherein cross members are disposed between the first and second casings at intervals to space the casings apart.

11. A seafloor vertical hoisting system as claimed in claim 10, wherein the cross members are hollow and connected between the first and second casings to equalise pressure differences between the first and second casings.

12. A method of hoisting ore from the seafloor using a seafloor vertical hoisting system as claimed in claim 1, the method including the steps of:
feeding ore into the plurality of containers; and
hoisting the plurality of containers towards an ore receiving vessel.

13. A spindle for a seafloor vertical hoisting system, the spindle comprising:
a frame rotatably connected to a support; and
a plurality of sheaves rotatably connected to the frame and adapted to engage at least one line operatively connecting a plurality of containers;
wherein the frame is selectively rotatable relative to the support and each of the sheaves is selectively rotatable relative to the frame; and
wherein the frame and/or sheaves are adapted to drive the at least one line.

14. A spindle as claimed in claim 13, wherein the frame and the plurality of sheaves are selectively rotated such that a corresponding container of the plurality of containers is disposed between two of the plurality of sheaves as the corresponding container travels around at least part of the spindle.

15. A spindle as claimed in claim 13, wherein the plurality of sheaves are prevented from rotating relative to the frame as a container of the plurality of containers travels around at least part of the spindle.

17. A spindle as claimed in claim 15, wherein the frame is adapted to rotate relative to the support when the plurality of sheaves are prevented from rotating relative to the frame.

17. A spindle for a seafloor vertical hoisting system, the spindle comprising:
a sheave rotatably connected to a support and adapted to engage at least one line operatively connecting a plurality of containers;
a cradle adapted to selectively rotate with the sheave and space each of the plurality of containers from the sheave as each of the plurality of containers travel around at least part of the sheave.

18. A spindle as claimed in claim 17, wherein the cradle selectively attaches to the sheave in order to selectively rotate with the sheave.

19. A spindle as claimed in claim 17, wherein the cradle comprises a recess that is adapted to receive at least part of each of the plurality of containers as the plurality of containers travel around at least part of the spindle.

20. A spindle as claimed in claim 17, wherein the cradle is adapted to engage at least part of the at least one line as the cradle rotates with the sheave around at least part of the spindle.

21. A spindle as claimed in claim 13, wherein the spindle is an upper spindle towards a top of the seafloor vertical hoisting system.

22. A spindle as claimed in claim 13, wherein the spindle is a lower spindle towards a bottom of the seafloor vertical hoisting system.

23. Using a spindle as claimed in claim 13 to hoist ore from the seafloor.

24. A method of constructing a seafloor hoisting system, the method including the steps of:
providing a plurality of conduits;
connecting the plurality of conduits to form at least one casing;
lowering the at least one casing towards the seafloor;
providing at least one line operatively connecting a plurality of containers;
locating at least part of the at least one line within the at least one casing; and
providing a drive mechanism adapted to drive the at least one line.

25. A method as claimed in claim 24, wherein the step of lowering the at least one casing towards the seafloor is performed while the at least one casing is being formed.

26. A method as claimed in claim 24, wherein the step of locating at least one line within the at least one casing is performed while the at least one casing is being formed.

27. A method as claimed in claim 24, further including the step of forming the at least one line into a continuous loop.

28. A method as claimed in claim 24, wherein the step of connecting the plurality of conduits to form at least one casing involves connecting the plurality of conduits to form a first casing adapted to at least partially encase the at least one line and the plurality of containers as they are hoisted relative to the seafloor and a second casing adapted to at least partially encase the at least one line and the plurality of containers as they are lowered towards the seafloor.

29. A method of hoisting ore from the seafloor, the method including the steps of:
providing ore from the seafloor to an ore hopper;
feeding ore from the ore hopper into a plurality of containers operatively connected by at least one line located within at least one casing; and
hoisting the plurality of containers towards an ore receiving vessel.

30. A method as claimed in claim 29, wherein the at least one casing is formed from a plurality of conduits.

31. A method as claimed in claim 29, wherein the step of providing ore from the seafloor to an ore hopper includes using an ore recovery apparatus to provide the ore to the ore hopper.

32. A method as claimed in claim 29, further including the step of using a drive mechanism to drive the at least one line.

33. A method as claimed in claim 29, further including the step of lowering the plurality of containers towards the seafloor, and wherein the at least one casing is a first casing adapted to at least partially encase the at least one line and the plurality of containers as they are hoisted towards the ore receiving vessel and a second casing adapted to at least partially encase the at least one line and the plurality of containers as they are lowered towards the seafloor.
